(19) United States
(12) Patent Application Publication
(10) Pub. No.: US 2007/0107006 A1
(43) Pub. Date: May 10, 2007

(54) OPTICAL DISC DRIVE

(75) Inventors: Chao-Yang Chen, Taipei (TW); Kuo-Chu Huang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 11/556,175

(22) Filed: Nov. 3, 2006

(30) Foreign Application Priority Data
Nov. 4, 2005 (TW) 94138717

(51) Int. Cl. G11B 7/00

(52) U.S. Cl. 720/685

(57) ABSTRACT

An optical disc drive including a case, a first circuit board, a tray, a second circuit board and a cable is provided. The first circuit board is disposed on the case and a cable protection structure is located on the case. The tray is movably disposed inside the case, and the second circuit board is disposed on the tray. Two ends of the cable are electrically connected with the first circuit board and the second circuit board, respectively. The cable has at least one folding portion located in the cable protection structure.

### CROSS-REFERENCE TO RELATED APPLICATION

This application claims the priority benefit of Taiwan application serial no. 94138717, filed Nov. 4, 2005. All disclosure of the Taiwan application is incorporated herein by reference.

### BACKGROUND OF THE INVENTION

1. Field of Invention

The present invention relates to an optical disc drive. More particularly, the present invention relates to an optical disc drive having cable protection structure located on the case.

2. Description of Related Art

An optical disc has advantages such as low price, portability, large storage volume, easy preservation, long storage life, low cost and durability, the optical disc has gradually substituted the conventional magnetic memory medium and become an indispensable optical storage medium. As the widespread use of the optical disc, the optical disc player used for accessing the information stored in an optical disc has also become one of the common electronic products in our daily life.

FIG. 1 is a diagram of a conventional optical disc drive. Referring to FIG. 1, the optical disc drive 100 includes a case 110, a first circuit board 120, a tray 130, a second circuit board 140 and a cable 150. The case 110 includes an upper case 112 and a lower case 114. The first circuit board 120 is disposed on the case 110, and the second circuit board 140 is disposed on the tray 130, wherein the tray 130 is movably disposed inside the case 110. Two ends of the cable 150 are electrically connected with the first circuit board 120 and the second circuit board 140, respectively. The cable 150 of the conventional optical disc drive 100 is a flexible printed circuit (FPC), and the circuitry is arranged as U-shaped.

As shown in FIG. 1, the two ends of the cable 150 are electrically connected with the first circuit board 120 and the second circuit board 140, respectively. Moreover, the cable 150 near the first circuit board 120 folds, turns a U-shape, and then is connected with the second circuit board 140. However, the cost of the U-shaped cable is high and the delivery period is long.

### SUMMARY OF THE INVENTION

Accordingly, the present invention is directed to provide an optical disc drive, suitable for a cable with low cost and short delivery period. In addition, the problem of the cable being abraded when the tray enters into/ejects from the case can be eliminated.

The present invention provides an optical disc drive, including a case, a first circuit board, a tray, a second circuit board and a cable. The first circuit board is disposed on the case and a cable protection structure is located on the case. The tray is movably disposed inside the case, and the second circuit board is disposed on the tray. Two ends of the cable are electrically connected with the first circuit board and the second circuit board, respectively. The cable has at least one folding portion located in the cable protection structure.

According to one embodiment of the present invention, the cable includes a plurality of straight metal lines and an insulation material. The insulation material covers these straight metal lines. Wherein, these straight metal lines are parallel to each other and disposed on a same plane.

According to one embodiment of the present invention, the cable may be a flexible flat cable or a flexible printed circuit.

According to one embodiment of the present invention, the cable protection structure may be a concave portion, and the folding portion of the cable is disposed in the concave portion.

According to one embodiment of the present invention, the cable protection structure may be a protrusion, and the folding portion of the cable is disposed near the protrusion portion.

According to one embodiment of the present invention, the cable protection structure may be a thin portion, and the folding portion of the cable is disposed in the thin portion.

According to one embodiment of the present invention, the cable protection structure may be an opening, and the folding portion of the cable is disposed in the opening.

According to one embodiment of the present invention, the optical disc drive further includes a data access module disposed on the tray, and the second circuit board is electrically connected with the data access module.

As the optical disc drive of the present invention has a cable protection structure, straight cable can be used in the optical disc drive without worrying about the abrasion of the folding portion. Thus, the cost is reduced, and the delivery period is shortened.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional optical disc drive.

FIG. 2 and FIG. 3 are a perspective view and a locally enlarged view of an optical disc drive according to one embodiment of the present invention, respectively.

FIG. 4A to FIG. 4C are the diagrams of cable protection structures according to the other three embodiments of the present invention, respectively.

FIG. 5A and FIG. 5B are the perspective view and the top view of the lower case and the cable according to another embodiment of the present invention, respectively.

FIG. 6A and FIG. 6B are the perspective view and the top view of the lower case and the cable according to another embodiment of the present invention, respectively.

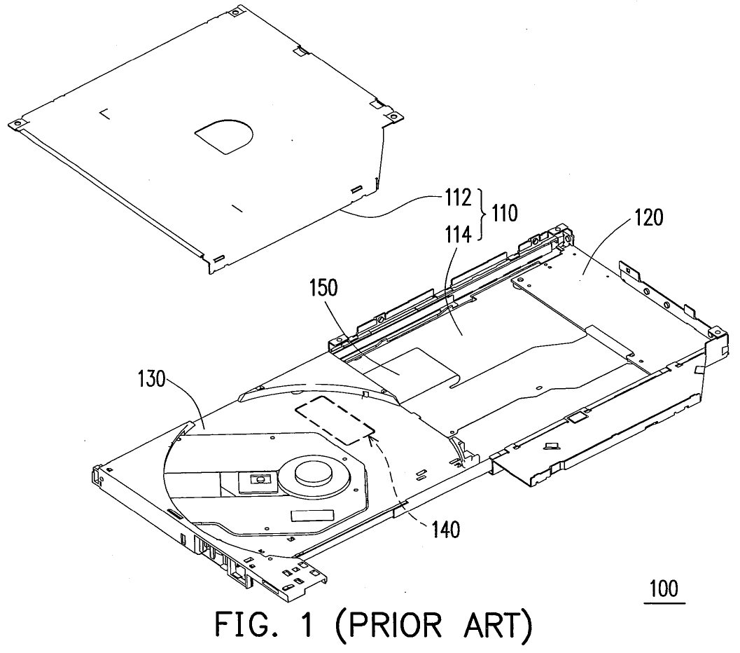

### DESCRIPTION OF EMBODIMENTS

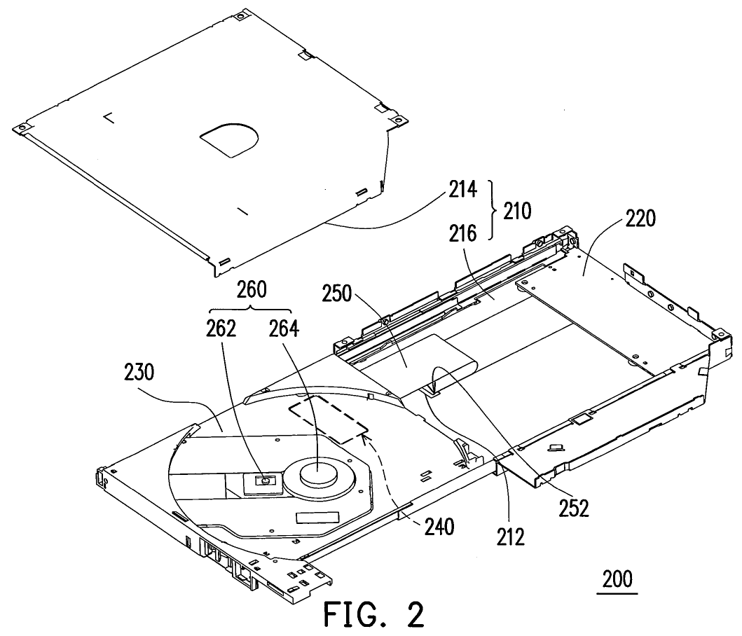

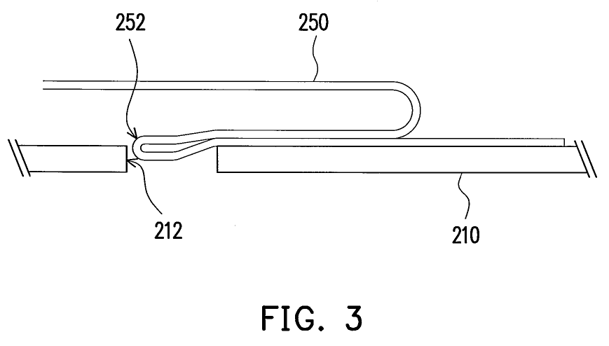

FIG. 2 and FIG. 3 are the perspective view and the locally enlarged view of an optical disc drive according to one embodiment of the present invention, respectively. Referring to FIG. 2, the optical disc drive 200 includes a case 210, a first circuit board 220, a tray 230, a second circuit board 240 and a cable 250. The case 210 includes an upper case 214 and a lower case 216 and has a cable protection structure 212. The first circuit board 220 is disposed on the case 210, and the second circuit board 240 is disposed on the tray 230 wherein the tray 230 is movably disposed inside the case 210. Two ends of the cable 250 are electrically connected with the first circuit board 220 and the second circuit board 240, respectively. The cable 250 has at least one folding portion 252 located in the cable protection structure 212. The folding portion 252 of the cable 250 can be protected by the design of the cable protection structure 212 so as to avoid damage resulted from the abrasion of the tray 230 while the tray 230 enters into/ejects from the case 210.

In addition, the optical disc drive 200 further includes a data access module 260, disposed in the tray 230, and the second circuit board 240 is electrically connected with the data access module 260. The data access module 260 may include a pickup head 262 and a turntable 264. In this embodiment, the cable 250 may be a flexible flat cable or a flexible printed circuit. In detail, taking the flexible flat cable as an example, the cable 250 includes a plurality of straight metal lines and an insulation material. The insulation material covers these straight metal lines. These straight metal lines are parallel to each other and disposed on a same plane. As the flexible flat cable has the advantage of low cost and short delivery period, the cost of the optical disc drive 200 can be reduced and the delivery period of the optical disc drive 200 can be shortened by using the cable 250. Moreover, using the flexible flat cable as the cable 250, although the folding portion 252 is relatively thick, the folding portion 252 can be protected by the cable protection structure 212 so as to avoid the folding portion 252 from being abraded by the tray 230 when the tray 230 is entering into/ejecting from the case 210.

In the embodiment, the cable protection structure 212 may be an opening, and the folding portion 252 of the cable 250 is disposed in the opening.

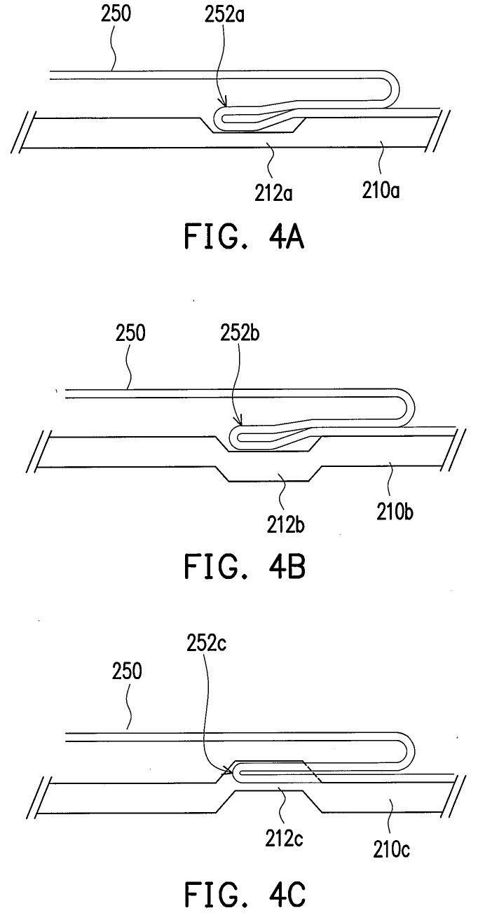

The following will refer to FIG. 4A to FIG. 4C, which illustrate the cable protection structures according to other three embodiments of the present invention, respectively.

In FIG. 4A, the cable protection structure 212a is a thin portion, and the folding portion 252a of the cable 250 is disposed in the thin portion. The formation method of the thin portion is by thinning the case 210a under the folding portion 252a to a downward depth without perforating the case 210a.

In FIG. 4B, the cable protection structure 212b is a concave portion, and the folding portion 252b of the cable 250 is disposed in the concave portion. The formation method of the concave portion is to punch the case 210b under the folding portion 252b to protrude downward.

In FIG. 4C, the cable protection structure 212c is a protrusion portion, and the folding portion 252c of the cable 250 is disposed near the protrusion portion. The formation method of the protrusion portion is to punch the case 210c beside the folding portion 252c to protrude a part in the case 210c. It is to be noticed that, when the cable protection structure 212c is a protrusion portion, the folding portion 252c of the cable 250 is disposed near the protrusion portion. Accordingly, the cable protection structure 212c can protect the folding portion 252c.

Of course, the above mentioned different designs of the widths and the depths of the cable protection structures 212a, 212b and 212c can be adjusted according to the size of the folding portions 252a, 252b and 252c.

Therefore, the preferred embodiments apply the design of the cable protection structure disposed on the case of the optical disc drive, so that the folding portion of the cable can be protected from the abrasion when the tray enters into/ejects from the optical disc drive.

In addition, referring to FIG. 2, the cable 250 may be folded once between one connection end of the cable 250 with the second circuit board 240 and the folding portion 252 in advance, so as to preserve a predefined length, so that the tray can recede a distance smoothly. In other words, when the tray 230 recedes a distance, the folding portion of the cable 250 can be straightened.

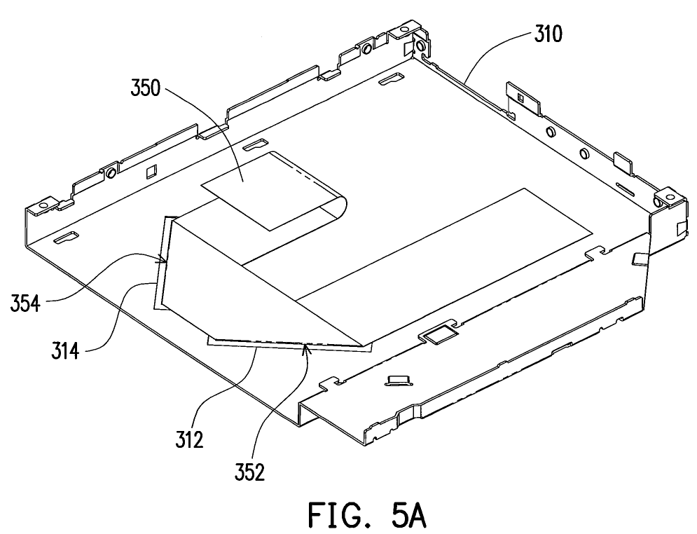

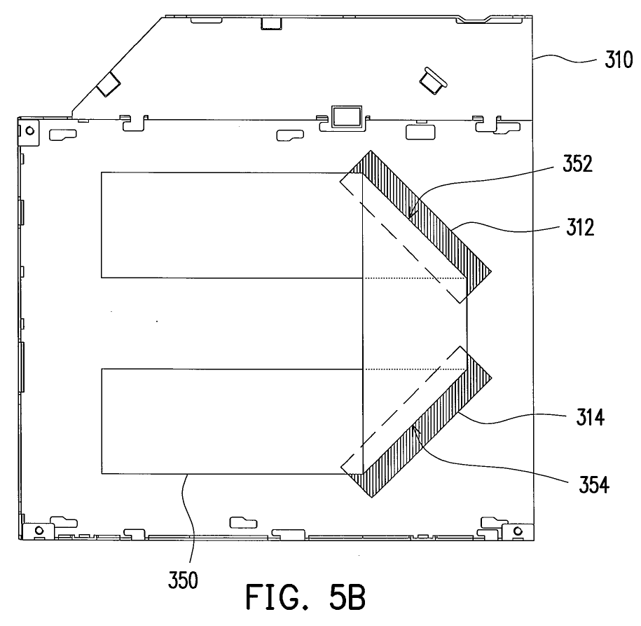

FIG. 5A and FIG. 5B are the perspective view and the top view of the lower case and the cable according to another embodiment of the present invention, respectively. For the convenience of description, FIG. 5A and FIG. 5B only show the lower case and the cable of the optical disc drive; the upper case, the circuit board and the tray are omitted. Referring to FIG. 5A and FIG. 5B, the embodiment is similar with the embodiment in FIG. 2, and the difference is that: the cable 350 has two folding portions 352, 354, and the case 310 has a cable protection structure 312 and a cable protection structure 314. The two folding portions 352, 354 are disposed in the two cable protection structures 312, 314, respectively. The cable 350 is folded twice in bevel to form the two folding portions 352, 354. Also, the design of the cable protection structure 312, 314 can effectively prevent the cable 350 from abrasion when the tray 230 is entering into/ejecting from the case 310.

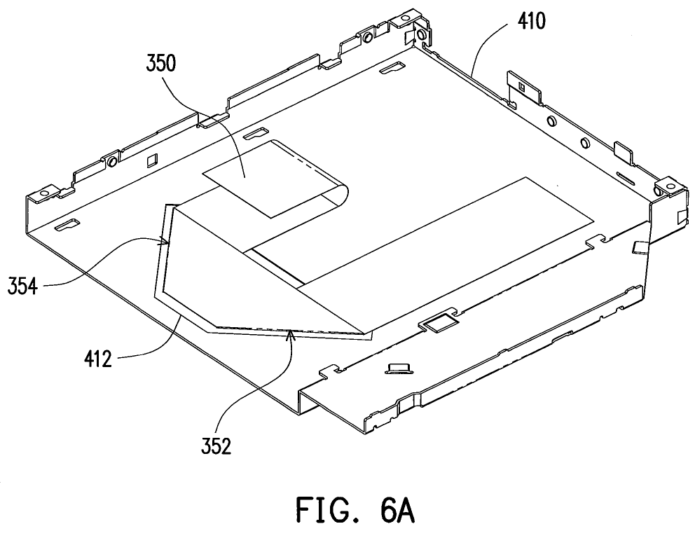

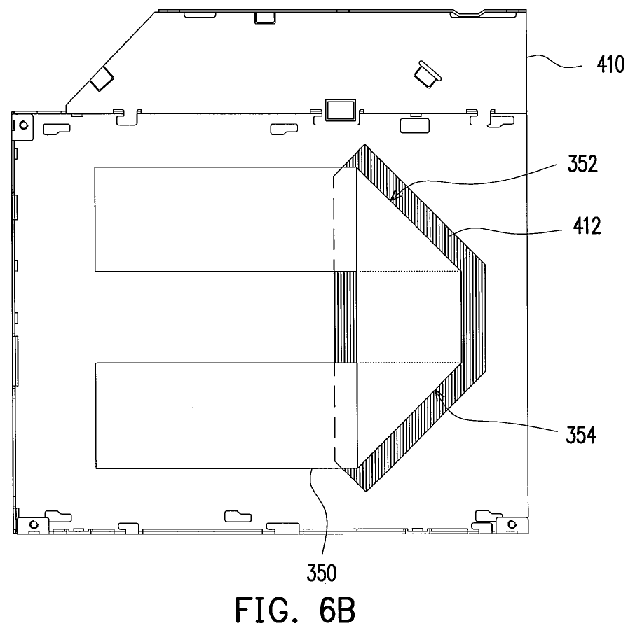

FIG. 6A and FIG. 6B are the perspective view and the top view of the lower case and the cable according to another embodiment of the present invention, respectively. For the convenience of description, FIG. 6A and FIG. 6B only show the lower case and the cable of the optical disc drive; the upper case, the circuit board and the tray are omitted. Referring to FIG. 6A and FIG. 6B, the embodiment is similar with the embodiment in FIG. 5A, and the difference is that: the case 410 has a cable protection structure 412 which can simultaneously cover both the folding portions 352, 354 and a part of the cable near the folding portions 352, 354. As shown in FIG. 6A and FIG. 6B, the two folding portions 352, 354 and the part of the cable 350 near the folding portions 352, 354 form a trapezium region, and the cable protection structure 412 is disposed under the trapezium. Therefore, the cable protection structure 412 can effectively prevent the cable 350 from abrasion by the tray 230.

It can be learned from the above that, the cable protection structure 412 may be disposed at the suitable location on the case under the cable 350 to directly protect the cable 350 or to provide extra space for the extension of the cable 350.

As the optical disc drive of the present invention has cable protection structure, the folding portion of the cable can be protected while the tray is entering into/ejecting from the optical disc drive so that the abrasion is reduced. In addition, as the optical disc drive of the present invention has the cable protection structure, the straight line cable can be used without worrying about the abrasion caused by the thickness of the folding portion. Furthermore, the cost can be reduced and the delivery period can be shortened.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc drive, comprising:
a case, wherein a cable protection structure is located on the case;
a first circuit board, disposed on the case;
a tray, movably disposed inside the case;
a second circuit board, disposed on the tray; and
a cable, wherein two ends of the cable are electrically connected with the first circuit board and the second circuit board respectively, and the cable has at least one folding portion located in the cable protection structure.

2. The optical disc drive as claimed in claim 1, wherein the cable includes:
a plurality of straight metal lines; and
an insulation material, covering the straight metal lines, wherein the straight metal lines are parallel to each other and disposed on a same plane.

3. The optical disc drive as claimed in claim 1, wherein the cable is a flexible flat cable or a flexible printed circuit.

4. The optical disc drive as claimed in claim 1, wherein the cable protection structure includes a concave portion, and the folding portion of the cable is disposed in the concave portion.

5. The optical disc drive as claimed in claim 1, wherein the cable protection structure includes a protrusion portion, and the folding portion of the cable is disposed near the protrusion portion.

6. The optical disc drive as claimed in claim 1, wherein the cable protection structure includes a thin portion, and the folding portion of the cable is disposed in the thin portion.

7. The optical disc drive as claimed in claim 1, wherein the cable protection structure includes an opening, and the folding portion of the cable is disposed in the opening.

8. The optical disc drive as claimed in claim 1 further includes a data access module disposed on the tray, and the second circuit board is electrically connected with the data access module.
